(19) United States
(12) Patent Application Publication
(10) Pub. No.: US 2025/0233550 A1
(43) Pub. Date: Jul. 17, 2025

(54) SPRING CLAMPS AND RELATED METHODS FOR CLAMPING FORCE DISTRIBUTION AND RETENTION

(71) Applicant: The Board of Regents of the University of Oklahoma, Norman, OK (US)

(72) Inventor: Andres F. Cavieres Pinilla, Norman, OK (US)

(73) Assignee: The Board of Regents of the University of Oklahoma, Norman, OK (US)

(21) Appl. No.: 19/016,472

(22) Filed: Jan. 10, 2025

Related U.S. Application Data
(60) Provisional application No. 63/620,753, filed on Jan. 12, 2024.

(51) Int. Cl. H02S 30/00; F16B 2/24

(52) U.S. Cl. CPC H02S 30/00; F16B 2/245

(57) ABSTRACT

Clamping systems including a clamp configured to clamp a photovoltaic panel flange to a base bracket flange are generally described. In some embodiments, the clamp may include two or more sets of legs connected to each other, each set of legs extending from an apex joint, with each leg including a receiving slot for receiving the panel flange and bracket flange therein. In some embodiments, the clamp includes teeth configured to interlock with grooves formed on the bracket flange.

### CROSS-REFERENCE TO RELATED APPLICATIONS

This application claims the benefit of priority under 35 U.S.C. § 119 (e) of U.S. Provisional Application Ser. No. 63/620,753, filed Jan. 12, 2024, the disclosure of which is incorporated herein by reference in its entirety.

### FIELD

Disclosed embodiments are generally related to spring clamps and related methods for clamping force distribution and retention.

### BACKGROUND

Photovoltaic (PV) panels are generally mounted onto mounting structures, which may be freestanding or attached to other structures, such as roofs, awnings, etc. The solar panels are commonly attached to the mounting structures using combinations of conventional fasteners such as bolts, nuts, washers, and rivets.

### SUMMARY

In some embodiments, a clamp for connecting a bracket to a frame is provided. The clamp comprises a first clamp section and a second clamp section connected to the first clamp section. The first clamp section comprises a first pair of legs configured to move between a compressed configuration with the first pair of legs compressed towards one another and an expanded configuration. The first clamp section also comprises a first plurality of receiver slots, each of the first plurality of receiver slots formed in a respective one of the first pair of legs. The first plurality of receiver slots is configured to receive a portion of the bracket and a portion of the frame therein. The second clamp section comprises a second pair of legs configured to move between a compressed configuration with the second pair of legs compressed towards one another and an expanded configuration. The second clamp section also a second plurality of receiver slots, each of the second plurality of receiver slots formed in a respective one of the second pair of legs. The second plurality of receiver slots are configured to receive a portion of the bracket and a portion of the frame therein. The clamp also comprises a flexible connection extending between and connecting the first clamp section and the second clamp section. The first plurality of receiver slots is aligned with the second plurality of receiver slots such that a plane extends through both the first plurality of receiver slots and the second plurality of receiver slots in both the compressed configurations and the expanded configurations.

In some embodiments, a clamping system is provided. The clamping system comprises a bracket including a plurality of grooves formed on a lower surface of the bracket, wherein the plurality of grooves extends substantially parallel to an edge of the bracket, and a clamp configured to approximate the bracket to a frame. The clamp comprises a pair of legs configured to move between a compressed configuration with the pair of legs compressed towards one another and an expanded configuration, a plurality of receiver slots, each of the plurality of receiver slots formed in a respective one of the pair of legs, wherein the plurality of receiver slots is configured to receive a portion of the bracket and a portion of the frame therein, a plurality of teeth extending from one or more edges of each of the plurality of receiver slots and configured to interlock with the plurality of grooves to prevent movement of the clamp relative to the bracket in a direction substantially parallel to a direction in which the plurality of receiver slots extends.

In some embodiments, a clamping system for clamping a solar panel to a base is provided. The clamping system comprises a bracket of the base, a frame of the solar panel, and a clamp configured to approximate the bracket to the frame. The clamp comprises a first clamp section and a second clamp section connected to the first clamp section. The first clamp section comprises a first pair of legs configured to move between a compressed configuration with the first pair of legs compressed towards one another and an expanded configuration. The first clamp section also comprises a first plurality of receiver slots, each of the first plurality of receiver slots formed in a respective one of the first pair of legs. The first plurality of receiver slots is configured to receive a portion of the bracket and a portion of the frame therein. The second clamp section comprises a second pair of legs configured to move between a compressed configuration with the second pair of legs compressed towards one another and an expanded configuration. The second clamp section also a second plurality of receiver slots, each of the second plurality of receiver slots formed in a respective one of the second pair of legs. The second plurality of receiver slots are configured to receive a portion of the bracket and a portion of the frame therein. The clamp also comprises a flexible connection extending between and connecting the first clamp section and the second clamp section. The first plurality of receiver slots is aligned with the second plurality of receiver slots such that a plane extends through both the first plurality of receiver slots and the second plurality of receiver slots in both the compressed configurations and the expanded configurations.

In any of the above embodiments relating to a clamp or clamping system, the flexible connection comprising a bridge extending between the first clamp section and the second clamp section is provided.

In any of the above embodiments relating to a clamp or clamping system, a tab disposed on and extending out from the bridge and configured to engage and be retained in an opening formed in at least one of the panel or the frame is provided.

In any of the above embodiments relating to a clamp or clamping system the tab being integrally formed with the bridge and be deformed out of plane with the bridge is provided.

In any of the above embodiments relating to a clamp or clamping system, relief slots disposed adjacent to a connection between the tab and the bridge and configured increase a flexibility of the tab to an applied force are provided.

In any of the above embodiments relating to a clamp or clamping system, the first pair of legs may meet at a first apex, and the second pair of legs may meet at a second apex.

In any of the above embodiments relating to a clamp or clamping system, a plurality of teeth formed in at least one of upper edges or lower edges of the first plurality of receiver slots and in at least one of upper edges or lower edges of second plurality of receiver slots are provided.

In any of the above embodiments relating to a clamp or clamping system wherein the clamp may be formed from a single piece of sheet metal.

In any of the above embodiments relating to a clamp or clamping system, one or more stiffening ribs formed on one or more legs of the first and second legs are provided. Each stiffening rib is located adjacent to an associated receiver slot of an associated leg of the one or more legs.

In any of the above embodiments relating to a clamp or clamping system, one or more additional clamp sections disposed between the first clamp section and the second clamp section is provided.

In any of the above embodiments relating to a clamp or clamping system, a plurality of relief slots is provided. Each relief slot of the plurality of relief slots is associated with one receiver slot of the first and second plurality of receiver slots.

A method of connecting a bracket to a frame is provided. The method comprises applying an external force to a clamp to transition a first pair of legs of the clamp and a second pair of legs of the clamp connected to the first pair of legs from a first expanded configuration to a second compressed configuration, receiving a portion of the bracket and a portion of the frame within a plurality of receiver slots, each of the plurality of receiver slots formed in a respective one of each of the first pair of legs and second pair of legs, and removing the external force from the external leg of the first pair of legs and from the external leg of the second pair of legs to allow the first and second pairs of legs to at least partially return to the first expanded configuration to clamp the bracket and frame in each of the plurality of receiver slots.

In any of the above embodiments relating to a method of connecting a bracket to a frame, scratching at least one of the bracket or the frame with teeth formed in the plurality of receiver slots is provided.

In any of the above embodiments relating to a method of connecting a bracket to a frame, retaining a tab disposed on and extending out from a bridge of the clamp in at least one opening formed in at least one of the panel and the bracket is provided.

In any of the above embodiments relating to a method of connecting a bracket to a frame, the method retaining a plurality of locking tabs extending from the plurality of receiver slots in the exterior leg of the first pair of legs and the exterior leg of the second pair of legs in openings formed in at least one of the panel and the bracket is provided.

In any of the above embodiments relating to a method of connecting a bracket to a frame, pressing load distribution flanges formed on a lower edge of at least one of the plurality of receiver slots against a bottom surface of the bracket is provided.

In any of the above embodiments relating to a method of connecting a bracket to a frame applying an external force to a clamp may comprise applying an external force to an exterior leg of the first pair of legs of a clamp and to an exterior leg of the second pair of legs of the clamp.

In any of the above embodiments of a clamping system, the frame may be a frame of a solar panel.

In any of the above embodiments of a clamping system, the pair of legs may be a first pair of legs, and the clamping system may further comprises a second pair of legs connected to the first pair of legs, and a flexible connection extending between and connecting the first pair of legs to the second pair of legs.

In any of the above embodiments of a clamping system the second pair of legs may be symmetrical with the first pair of legs.

In any of the above embodiments of a clamping system one or more flanges extending from one or more legs of the pair of legs is provided. The one or more flanges comprise a plurality of teeth extending along an edge of the one or more flanges and configured to interlock with the plurality of grooves.

In any of the above embodiments of a clamping system, one or more stiffening ribs formed on one or more legs of the pair of legs is provided. Each stiffening rib is located adjacent to an associated receiver slot of an associated leg.

A method of connecting a bracket to a frame is provided. The method comprises applying an external force to a clamp to transition a first exterior leg and a second exterior leg of the clamp from an expanded configuration to a compressed configuration, receiving a portion of the bracket and a portion of the frame within a plurality of receiver slots, each of the plurality of receiver slots formed in a respective one of the first and second exterior legs, removing the external force from the first exterior leg and the second exterior leg to allow the first and second exterior legs to at least partially return to the expanded configuration, and preventing movement of the clamp relative to the bracket in a direction substantially parallel to a direction in which the plurality of receiver slots extend by interlocking a plurality of teeth extending along a lower edge of each of the plurality of receiver slots with a plurality of grooves extending at least partially along an edge of the bracket on a lower surface of the bracket.

In any of the above embodiments related to a method of connecting a bracket to a frame, scratching at least one of the bracket or the frame with teeth formed in the plurality of receiver slots is provided.

In any of the above embodiments related to a method of connecting a bracket to a frame retaining a plurality of locking tabs extending from receiver slots of the plurality of receiver slots formed in the first and second exterior legs in openings formed in at least one of the panel and the bracket is provided.

In any of the above embodiments related to a method of connecting a bracket to a frame, interlocking a plurality of teeth extending along one or more flanges extending from one or more of the first exterior leg and the second exterior leg with the plurality of grooves.

In any of the above embodiments related to a method of connecting a bracket to a frame, applying an external force to the clamp comprises applying an external force to the first exterior leg and a second exterior leg of the clamp is provided.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A shows a perspective view of a PV panel frame attached to a base bracket via a spring clamp according to an embodiment.

FIG. 1B shows a perspective view of the spring clamp according to the embodiment of FIG. 1A.

FIG. 2A shows a front view of the spring clamp in a compressed configuration according to the embodiment of FIG. 1A.

FIG. 2B shows a front view of the spring clamp in an expanded configuration according to the embodiment of FIG. 1A.

FIG. 3 shows a perspective view of a spring clamp according to an embodiment.

FIG. 4A shows a perspective view of a PV panel frame attached to a base bracket via a spring clamp according to an embodiment.

FIG. 4B shows a perspective view of the spring clamp according to the embodiment of FIG. 4A.

FIG. 5A shows a bottom perspective view of a PV panel frame attached to a base bracket via a spring clamp according to an embodiment.

FIG. 5B shows a perspective view of the spring clamp according to the embodiment of FIG. 5A.

FIG. 6A shows a perspective view of a PV panel frame attached to a base bracket via a spring clamp according to an embodiment.

FIG. 6B shows a perspective view of a spring clamp according to the embodiment of FIG. 6A.

FIG. 7A shows a bottom perspective view of a PV panel frame attached to a base bracket via a spring clamp according to an embodiment.

FIG. 7B shows a perspective view of the spring clamp according to the embodiment of FIG. 7A.

FIG. 7C shows a side view of the spring clamp according to the embodiment of FIG. 7A.

FIG. 8A shows a bottom perspective view of a PV panel frame attached to a base bracket via a spring clamp according to an embodiment.

FIG. 8B shows a perspective view of the spring clamp according to the embodiment of FIG. 8A.

### DETAILED DESCRIPTION

Fasteners such as bolted connections are conventionally used to assemble PV assemblies to a mounting structure in a variety of solar markets. The Inventor has recognized that the use of conventional fasteners poses several problems. First, panel dimensions and the position of mounting holes in panel frames are not typically standardized across manufacturers. This lack of standardization requires vendors to customize mounting hardware for each solar project to match the specifications of different panels, which can extend manufacturing lead times and increase supply chain costs. Second, the use of bolted connections can increase the complexity and time required for panel installation, along with the risk of installer error. For example, mounting holes at the bottom of PV panel frames may need to be manually aligned with mating holes in the supporting structure (e.g., base brackets), then bolts may need to be threaded, washers inserted, and nuts temporarily placed. These steps are taken four times for each PV panel, typically in conditions that are not ergonomic or comfortable for the installers. In each instance, these parts and tools may be missing, lost, stolen, or fall over the panels, potentially causing damage to the solar cells. Finally, nuts and bolts must be tightened at specific torque values, which in practice is very difficult to achieve. Over-torquing is a common cause for the failure of bolts under high wind loads, whereas under-torquing may lead to loose bolts and nuts, due to vibrations and other environmental conditions. This adds maintenance costs by requiring constant checking and re-tightening of large numbers of bolts and nuts on site.

While certain spring clamp designs may alleviate some of the above issues, these earlier spring clamp designs generally include two legs extending from an apex joint and corresponding receiver slots formed in the legs to apply a clamping force to a PV panel and bracket received in the receiver slots. However, these spring clamps only apply clamping forces to a single area where the receiver slots are engaged with the PV panel and bracket.

In addition to the above, conventional fasteners and earlier spring clamp designs may not be suitable for larger PV panels, as larger PV panels are subjected to greater wind and snow loads. Such increased loads may increase the force needed to hold the PV panels to the base. However, simply increasing the force in a single location used to hold PV panels to the base may not be desirable, as this will increase the pressure on the portions of the panel frames and brackets where the fasteners or clamps are attached. Correspondingly, this may lead to local deformation or other damage at these locations. It also may not be desirable to simply attach additional fasteners and/or clamps to reduce the resulting pressures and loads as this may result in corresponding larger installation costs.

In view of the above, the inventor has therefore recognized and appreciated the benefits associated with designs for an improved spring clamp with an increased clamping area to better distribute the increased loads experienced by larger PV panels. The inventor has also recognized and appreciated designs for improved spring clamps which resist retraction and lateral movement of the spring clamps from PV panels and base brackets when exposed to cyclical wind loads.

As noted above, in some embodiments, it may be desirable to reduce or maintain an amount of pressure applied to a PV panel, or other structure being clamped, while increasing the clamping force applied to the PV panel. To provide this functionality, in some embodiments a spring clamp may include multiple clamp sections that apply a desired amount of clamping force that are attached to one another over a predetermined length to provide the desired amount of pressure to the clamped assembly during use. In one such embodiment, a spring clamp includes a clamp body with at least two clamp sections connected to each other. The clamp sections may include pairs of flexible legs including receiver slots formed therein as elaborated on further below. Each pair of legs may be connected to an adjacent leg of that clamp section via an apex joint. In instances in which a leg is connected the leg of an adjacent clamp section, it may be considered an inner leg and may be connected to an adjacent inner leg of the adjacent clamp section via a flexible connection. In some embodiments, each pair of legs of the different clamp sections of the spring clamp may be “V” shaped, such that connected sets of legs together may form a “W” shaped or other corrugated shape. Each of the legs may include a receiver slot configured to receive a flange or other portion of the panel frame and base bracket. The receiver slots are configured such that compressing the legs towards one another increases a clearance of the receiver slots, so that the receiver slots may be slid over a frame flange and a bracket flange. Releasing the legs would allow the legs to expand back toward their original relaxed configuration, which may also be referred to as an expanded configuration. This would decrease the clearance of the receiver slots and clamp the panel flange against the bracket flange.

As noted above, in some embodiments, a spring clamp includes a clamp body with two or more clamp sections corresponding to two or more sets of legs connected to each other. With respect to locations of the different legs. Legs that are connected to the legs of adjacent clamp sections may be referred to as inner legs. Legs that are located on an exterior end portion of the spring clamp and are not connected to an adjacent leg of another clamp section may be referred to as an outer leg. Additionally, clamp sections disposed on opposing exterior end portions of the spring clamp may be referred to as exterior clamp section and clamp sections disposed between the exterior clamp sections may be referred to as interior clamp sections.

As also noted above, it may be desirable to reduce the chance of a PV panel pulling out of a spring clamp in a direction that is parallel to a direction of insertion of a PV panel and bracket into the spring clamp. This may be provided using features such as locking tabs that engage with another structure and/or teeth that may be engaged with one or more groves formed on a clamped structure to provide a lateral retention force to maintain the PV panel, bracket, and/or other structures within the spring clamp as detailed further below.

In some embodiments, a spring clamp includes a clamp body with at least two sets of legs that may be connected to each other by a bridge extending between these separate clamp sections. The clamping spring may include at least two exterior clamp sections, and optionally one or more interior clamp sections disposed between the two exterior clamp sections. The one or more bridges may extend between and be connected to the opposing inner legs of one or more adjacent clamp sections. The spring clamp may include locking tabs formed on and extending out from the outer legs of the two opposing exterior clamp sections. These locking tabs may extend in a direction that is oriented outward away from the associated outer leg of the exterior clamp section it is connected to. The locking tabs may be configured to be inserted and retained in corresponding slots formed in a corresponding portion of a bracket flange, PV panel flange, or other structure when the spring clamp is in the clamped configuration such that the locking tabs positioned in the corresponding slot resist lateral movement of the spring clamp relative to the flanges.

Similar to the above, in some embodiments, a spring clamp includes a clamp body with at least two sets of legs that may be connected to each other by a bridge extending between these separate clamp sections. The clamping spring may include at least two exterior clamp sections, and optionally one or more interior clamp sections disposed between the two exterior clamp sections. The one or more bridges may extend between and be connected to the opposing inner legs of one or more adjacent clamp sections. At least one interior locking tab may extend away from the associated bridge it is disposed on. The interior locking tab may be configured to be elastically deformed and inserted in a corresponding mounting hole, or other hole, formed on a PV panel flange and the bracket flange, or other appropriate structures, when the spring clamp is attached thereto. Correspondingly, the interior locking tab may resist movement of the spring clamp relative to the flanges, or other structure the spring clamp is attached to.

In some embodiments, a spring clamp includes a clamp body with at least one set of legs and a separate receiver slot formed in each of the legs. The receiver slots include a plurality of teeth extending along one or more edges of the receiver slots oriented towards a structure disposed in the associated receiver slot. The teeth are configured to interlock with a series of parallel grooves formed on a surface of a bracket flange that the teeth are configured to be engaged with in an engaged configuration with the bracket or other structure. For example, the teethe are sized and shaped to at least partially conform to a shape of the grooves such that the teeth resist being pulled out of the corresponding grooves in a direction parallel to an insertion direction into the receiver slots. For example, a distal leading edge of each tooth may be sloped to facilitate insertion of a structure and the grooves into the slot and a proximal edge of each tooth may be sloped in a direction that resists movement of the groove relative to the tooth when engaged. In one such embodiment, the teeth also have a steeper slope on a trailing edge, such that the teeth contact the parallel grooves and resist retraction of the spring clamp from the panel flange and bracket flange. Of course, other interlocking shapes may be used for the teeth and groves as well.

To help spread out the force applied to the surface of a PV panel, or other structure, it may be desirable to include one or more flanges that are configured to engage with a surface of a corresponding PV panel or other structure to apply a desired clamping force. This may be contrasted to a spring clamp where the edges of the receiver slots are the only load transfer structure in contact with the PV panel or other structure. In some such embodiments, a spring clamp may include a clamp body with at least two sets of legs connected to each other. Each set of legs may extend away from a respective apex joint. The spring clamp may include one or more load distribution flanges formed on a lower portion of one or more associated receiver slots of the legs. The flanges may extend outward away from the legs and associated receiver slot. The flanges are configured to be pressed against a lower surface of a bracket flange, PV panel, or other structure when the spring clamp is attached such that the load distribution flanges increase a clamping surface area of the spring clamp in contact with the associated surface of a structure the clamp is engaged with. Again, by increasing a surface area of a structure the spring clamp is engaged with, this may reduce a pressure associated with the clamping forces applied by the spring clamp.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

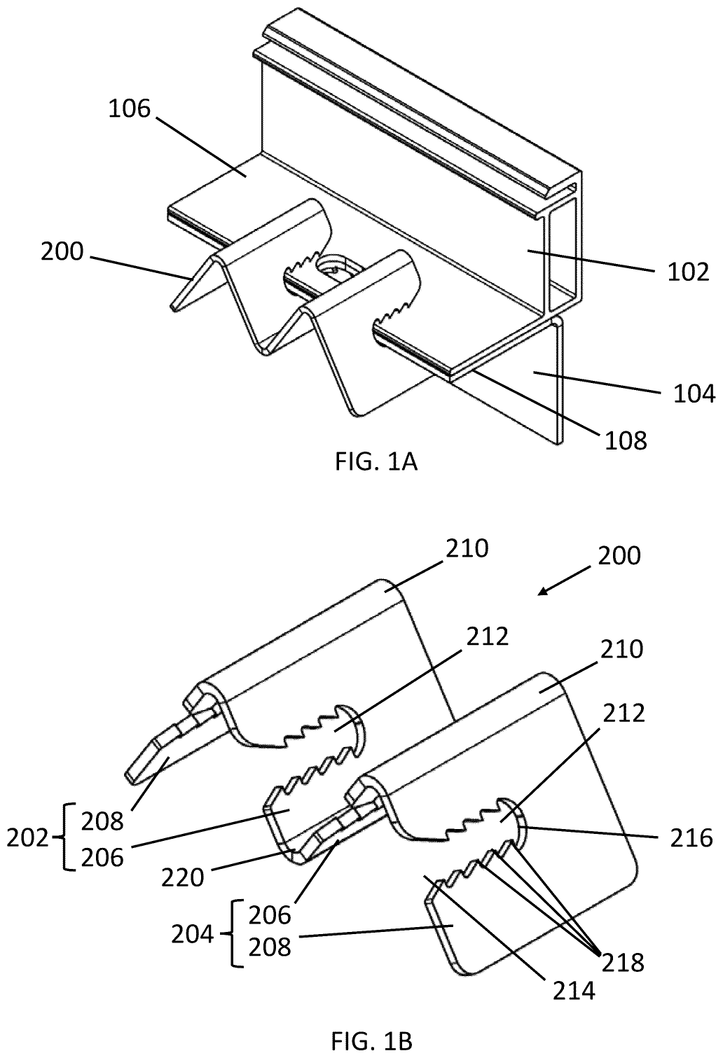

FIG. 1A shows a perspective view of a clamping system, with PV panel frame 102 affixed to a base bracket 104. The PV panel frame 102 includes one or more panel horizontal flanges 106 that extend along at least one side of the PV panel frame. Base bracket 104 includes one or more bracket horizontal flanges 108 that extend along at least one side of the base bracket 104. Base bracket 104 may be supported by, or attached to, a fixed structure (such as a roof, canopy or ground mounted structure) or to an articulating carrier that adjusts the angular position of the PV panel to optimize the collection of light. During installation, the panel frame 102 is positioned with respect to the base bracket 104 such that the panel horizontal flange 106 is aligned with the bracket horizontal flange 108. Spring clamp 200 captures and secures the panel horizontal flange 106 to the bracket horizontal flange 108 using a clamping force applied to these two structures. Of course, it should be understood that structures other than the illustrated PV panel frame 102 and base bracket 104 may be clamped together by the illustrated spring clamp 200 as the disclosure is not so limited.

FIG. 1B illustrates a perspective view of a spring clamp 200 according to an embodiment. In exemplary embodiments, the spring clamp 200 is made from a stamped spring-grade steel sheet metal with anti-corrosion properties (e.g., stainless, or galvanized), though other appropriate suitable materials exhibiting a desired amount of strength and elasticity may also be used. For example, the spring clamp 200, and other embodiments disclosed herein, may be constructed of materials including, but not limited to, metals such as steel, stainless steel, aluminum, and titanium, and metal alloys, composite reinforced metals, plastics and the like. In some embodiments, the spring clamp 200 is constructed from a conductive metal to provide a grounding path between the panel horizontal flange 106 and the bracket horizontal flange 108.

In some embodiments, a spring clamp 200 includes a clamp body with two or more clamp sections including corresponding separate sets of legs 202 and 204 connected to each other. Each set of legs 202 and 204 may include a pair of legs. In the depicted embodiment with two clamp sections, the two clamp sections each include an inner leg 206 and an outer leg 208 extending away from a respective apex joint 210 disposed between and connecting the corresponding legs to each other. Adjacent legs from adjacent clamp sections, such as the depicted inner legs 206 may be connected to each other by a flexible connection extending between them. This may connect the adjacent clamp sections to each other. This may form a corrugated structure extending between opposing end portions of the depicted clamp body. In some embodiments, an angle between the legs of a clamping section connected to each other at an apex joint 210 may be between 10° and 90° though other angles may also be used.

In some embodiments, each set of legs 202 and 204 corresponding to the different clamp sections of the spring clamp may be “V” shaped, such that connected sets of legs together may form a corrugated structure. For example, in instances where two clamp sections are connected to each other the resulting shape may be “W” shaped. However, any other suitable shape for each set of legs 202 and 204 as well as any appropriate number of clamp sections may be used to form a desired corrugated structure as the present disclosure is not limited by the shape of the spring clamp 200 and/or number of clamp sections.

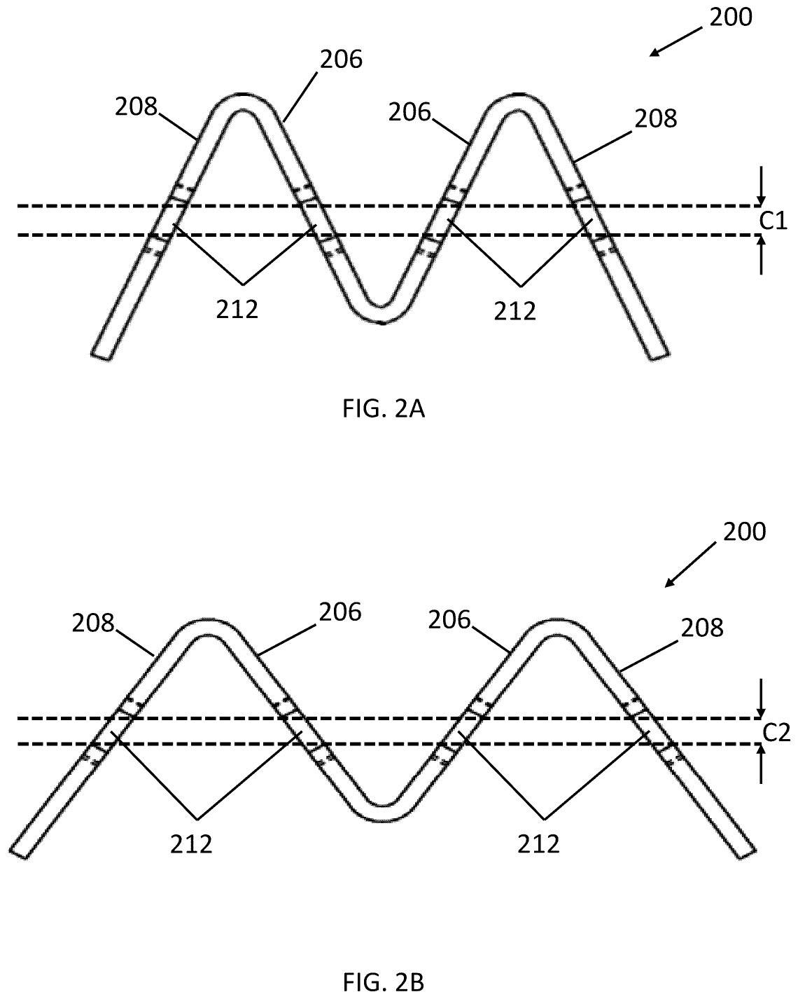

The thickness of the clamp body and the material of construction may be selected to permit the legs 206 and 208 to be approximated or compressed toward one another into a compressed configuration, as illustrated in FIG. 2A. When the compressive force is removed, the spring energy stored within the spring clamp 200 forces the legs 206 and 208 to separate into a relaxed configuration, as illustrated in FIG. 2B.

Each of legs 206 and 208 of the spring clamp 200 has a receiver slot 212 with a distal opening 214 formed therein. The receiver slot of each respective leg extends from the distal opening 214 towards an opposing proximal portion of the respective leg. As best illustrated in FIGS. 2A-2B, in some embodiments, the receiver slots 212 are arranged in a substantially normal, or orthogonal, relationship with respect to the legs 206 and 208 such that the receiver slots 212 are angled downward in an oblique manner when the spring clamp 200 is in a relaxed configuration. When in a compressed configuration (as illustrated in FIG. 2A), and due to the angular disposition of the legs 206 and 208 and the orientation of the receiver slots 212 within the legs 206 and 208, the receiver slots 212 together provide a first clearance (C1) that represents the height of the linear gap that extends through the receiver slots 212. When the legs 206 and 208 of the spring clamp 200 are in a relaxed configuration (as illustrated in FIG. 2B), the angular disposition of the legs 206 and 208 and the receiver slots 212 is reduced to provide a second clearance (C2) that is less than the first clearance (C1) in the compressed configuration. Second clearance (C2) may also be less than a combined thickness of panel horizontal flange 106 and bracket horizontal flange 108 such that when engaged with the structures, the spring clamp may be in a configuration that is between a fully compressed configuration and a fully relaxed configuration of the spring clamp.

In some embodiments, each of the receiver slots includes a plurality of teeth 218. The teeth 218 of the receiver slots 212 are configured to scratch the surface of a bracket horizontal flange 108 to increase the frictional resistance between the spring clamp, and the bracket horizontal flange 108, and/or any other suitable structure of the assembly. The teeth also increase the electrical conductivity between the spring clamp 200 and the bracket horizontal flange 108 by removing any non-conductive coatings applied to these components.

Below is an exemplary method of using the spring clamp to attach the PV panel to the base. Panel horizontal flange 106 is first aligned with bracket horizontal flange 108. A force is then applied to outer legs 208 to compress legs 206 and 208 together. Legs 206 and 208 are compressed until increased clearance (C1) is reached, which is at least the combined thickness of panel horizontal flange 106 and bracket horizontal flange 108. The opening 214 of each leg of the two or more clamping sections corresponding to the different set of legs 202 and 204 is then aligned with the flanges 106 and 108, or other structures, and spring clamp 200 is pushed forward such that the panel horizontal flange 106 and bracket horizontal flange 108 fit within the increased clearance (C1) of the receiver slots 212. Once the spring clamp 200 is fully advanced over the panel horizontal flange 106 and bracket horizontal flange 108, the compressive force on the legs 208 is released and the spring stored energy in the legs 206 and 208 causes them to expand. However, because clearance (C2) is less than the combined thickness of panel horizontal flange 106 and bracket horizontal flange 108, legs 206 and 208 are prevented from expanding back to the relaxed configuration and releasing all of the stored spring energy. This results in legs 206 and 208 expanding to an engaged configuration between the compressed configuration and the relaxed configuration, and at least a portion of the stored spring energy creating a compressive force between the panel horizontal flange 106 and bracket horizontal flange 108, holding the flanges 106 and 108 together, and clamping the PV panel 102 to the base bracket 104.

It is contemplated that the above exemplary method of using spring clamps to attach PV panels to bases may be used for any embodiment of a spring clamp described herein.

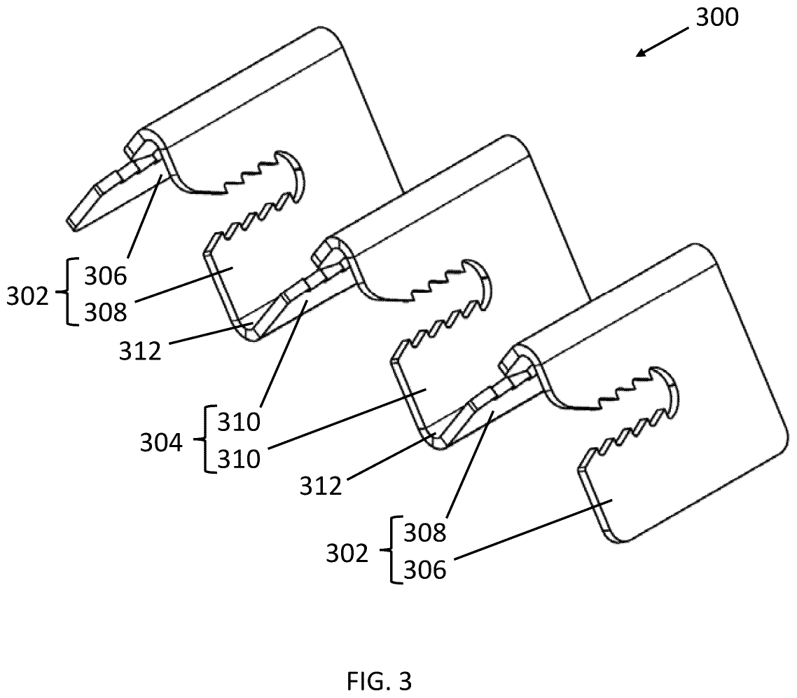

While the spring clamp shown in FIGS. 1A-1B includes two sets of legs, a spring clamp with any number of sets of legs is contemplated. For instance, FIG. 3 shows an embodiment of a spring clamp 300 with three separate clamp sections including three sets of legs. In this embodiment, Spring clamp includes two exterior sets of legs 302 and at least one interior set of legs 304. Each of the exterior sets of legs 302 include an exterior leg 306 and an interior leg 308. Each interior set of legs includes interior legs 310. Each interior leg 308 of the exterior sets of legs 302 are connected to an adjacent leg 310 of the interior set of legs 304 by a flexible connection 312. The number of interior sets of legs 304 (i.e., interior clamp sections) may be increased as desired. In some embodiments, the spring clamp may include two, three, or any number of interior sets of legs 304.

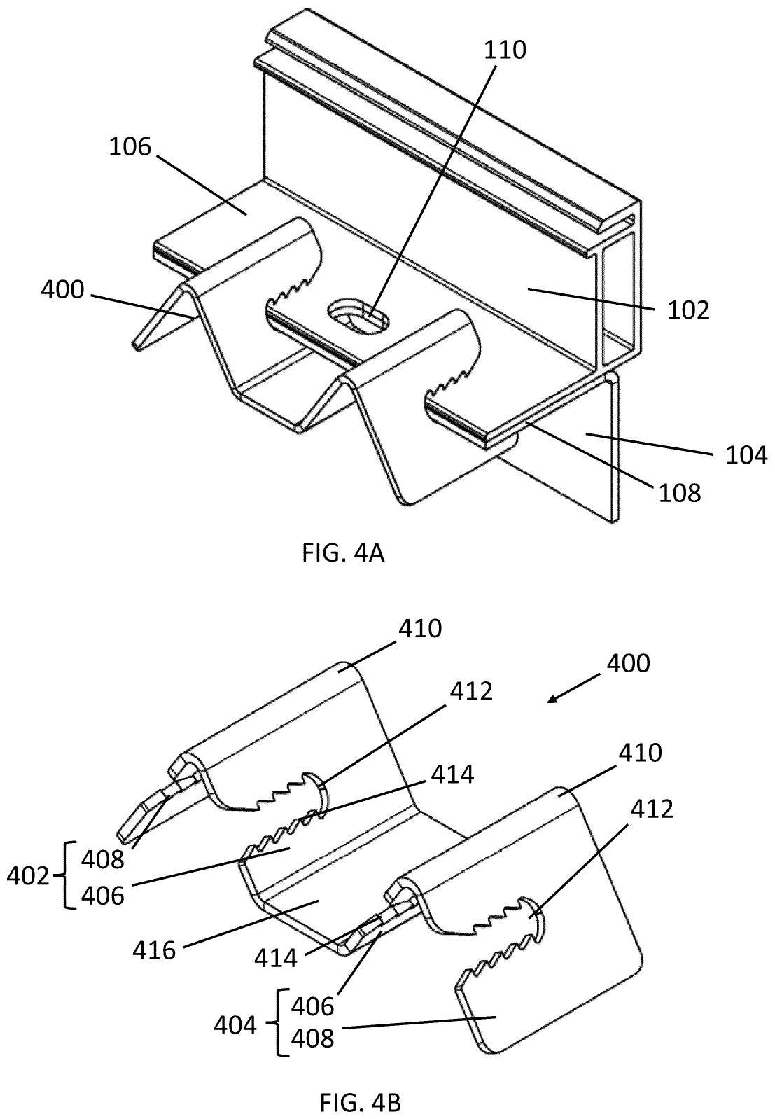

As noted previously, it may be desirable to control a spacing between adjacent connected clamp sections of a spring clamp to control an area over which the associated clamping forces are applied. FIG. 4A illustrates a perspective view of a frame of a PV panel 102 attached to a bracket 104 of a base via a spring clamp 400 according to an embodiment. FIG. 4B illustrates a perspective view of spring clamp 400 according to this embodiment. In some such embodiments, it may be desirable to increase spacing between each set of legs 402 and 404 of the spring clamp 400 while maintaining a size and shape of the legs included in each clamp section. Such a configuration may allow the clamping force of the spring clamp 400 to be distributed over a greater surface area of the panel horizontal flange 106 and the bracket horizontal flange 108, reducing the likelihood of local deformation of the panel horizontal flange 106 and bracket horizontal flange 108 at the points where spring clamps 400 are attached. Additionally, many panel horizontal flanges 106 and bracket horizontal flanges 108 include mounting holes 110 at locations along a length of the flanges 106 and 108 which may interfere with placement of attachment hardware such as spring clamps. For instance, many panel horizontal flanges 106 and bracket horizontal flanges 108 include mounting holes 100 near each corner of the PV panel. It may therefore be desirable for spring clamp 400 to be centered over or otherwise arranged to avoid applying clamping forces to pre-existing mounting holes 110 formed in the panel horizontal flange 106 and/or the bracket horizontal flange 108. This may also be desirable to help provide sufficient distance between the illustrated mounting holes 110 and clamping locations to reduce or avoid potential damage associated with stress concentrations and local deformation in the flanges 106 and 108 near the mounting holes 110.

In view of the above, in any of the embodiments disclosed herein, a spring clamp 400 may include one or more bridges 416, which may be connected to and extend between adjacent sets of legs 402 and 404 of adjacent clamp sections. For example, the interior leg 406 of each set of legs 402 and 404 may be connected to an adjacent interior leg of an adjacent set of legs such that the different clamp sections are connected to each other. The bridge may be connected to a portion of each associated leg at a portion of the leg that is located opposite from the respective apex joint 410 that the leg. In some embodiments, the bridge may be formed by opposing complementary bends connecting the bridge to the associated end portions of the connected legs.

The bridge 416 may have any suitable width to provide a desired load distribution and alignment as discussed above. In some embodiments, the bridge 416 has a sufficient width to increase a minimum distance between receiver slots 412 on the inner legs 406 by a factor of 1.5 to 2.5 as compared to the embodiment of FIGS. 1A-1B where adjacent clamp sections are directly attached to each other without a bridge. In some embodiments a width of the spring clamp 400 may be between 70 mm and 110 mm. In some embodiments, an apex joint width 410 may be between 15 mm and 85 mm apart.

In the depicted embodiment, the bridge 416 extending between adjacent sets of legs 402 and 404 is straight. However, a bridge 416 may be any suitable shape which connects the adjacent interior legs 406 to each other and is positioned vertically below a lower edge 414 (i.e., the closest edge) of each of the receiver slots 412 which would interfere with insertion of structures into the receiver slots. In some embodiments, bridge 416 is a generally flat structure extending between inner legs 406 and configured to be approximately parallel with the bracket horizontal flange 108 when attached. In other embodiments, elongate bridge 416 may be curved either towards or away from the bracket horizontal flange 108 (i.e., concave or convex). In other embodiments, the bridge 416 may have a “mesa” configuration, where portions of the bridge 416 connected to the associated interior legs 106 extend in directions that are oriented partially in a vertical direction from the adjacent end portions of the associated interior legs 406 towards the apex joints 410. The bridge may also include flat middle portion that extends between these portions attached to the interior legs 406. The flat middle portion may extend in a direction that is generally horizontal such that it is approximately parallel with the bracket horizontal flange 108 when the spring clamp is attached thereto. In some embodiments an upper surface of the mesa style elongate bridge 416 is configured to contact with a lower surface of the bracket horizontal flange 108 when the spring clamp 400 is attached. In other words, an upper surface of the mesa shaped bridge may extend above a lower edge of the receiver slots when the spring clamp is in the fully relaxed configuration and may be positioned vertically below the lower edge of the receiver slots when the spring clamp is in the fully compressed configuration. This may permit structures to be slid into the receiver slots in the compressed configuration and maintain the spring clamp in the desired location with an upper surface of the bridge oriented towards the structures (i.e., the bracket and PV panel) in contact with the adjacent structure in the receiver slots.

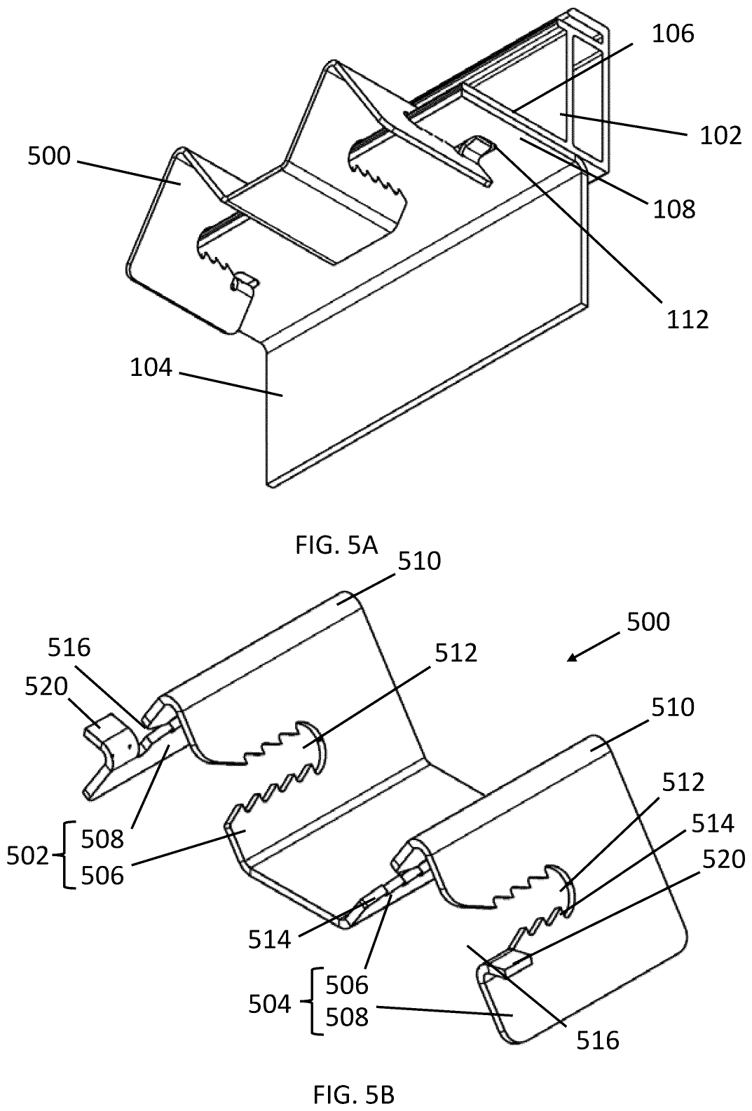

FIG. 5A shows a bottom perspective view of spring clamp 500 attached to panel horizontal flange 106 and bracket horizontal flange 108, and FIG. 5B shows perspective views of a spring clamp 500 that is configured to prevent lateral movement of the spring clamp relative to a structure clamped therein according to an embodiment. In the depicted embodiment, the spring clamp 500 includes at least one locking tab 520 which interlocks with at least one spring clamp slot 112 formed on another structure such as the illustrated bracket horizontal flange 108 or another structure such as the PV panel. Locking tabs 520 may prevent a spring clamp 500 from moving in a lateral direction relative to the bracket horizontal flange 108 once spring clamp 500 is attached, thus reducing a likelihood of the spring clamp 500 retracting from or becoming misaligned with the flanges 109 and 108 when subjected to wind or snow loads.

In some embodiments, locking tabs 520 are disposed on a lower edge 514 and at a distal end portion 516 of the receiver slot 512 adjacent to the opening of the receiver slot formed on each exterior leg 508. The locking tabs may extend outward in a direction that is angled relative to the legs in which they are formed and away from the clamp body. In the depicted embodiment, the locking tabs are formed in the exterior leg 508 of the two exterior clamp sections corresponding to the sets of legs 502 and 504 disposed on the two opposing end portions of the spring clamp 500. The interior legs may be free of locking tabs in some embodiments. Of course, while only two spring sections are illustrated, any number of interior spring sections disposed between the two exterior spring sections may also be included. In either case, the locking tabs 520 may be sized and shaped to fit in the spring clamp slots 112 formed in the bracket horizontal flange 108.

During use, when legs 506 and 508 are compressed, locking tabs 520 rotate with the receiver slots 512 on the outer legs 508 which may allow for an increased clearance (C2) provided by the receiver slots 512 in the compressed position. The spring clamp 500 is then advanced over the panel horizontal flange 106 and the bracket horizontal flange 108 such that the flanges are inserted into the receiver slots 512. Once the receiver slots 512 of the spring clamp 500 are fully advanced over the flanges 106 and 108, the compressive force on the legs 506 and 508 may then be removed to allow the legs 506 and 508 to move to the engaged configuration, forcing the locking tabs 520 into the spring clamp slots 112 on the bracket horizontal flange 108 in addition to clamping the structures in the receiver slots 512. In this fully engaged position, the locking tabs 520 are captured within the spring clamp slots 112 which may prevent the retraction and other lateral movement of the spring clamp 500 relative to the panel horizontal flange 106 and bracket horizontal flange 108.

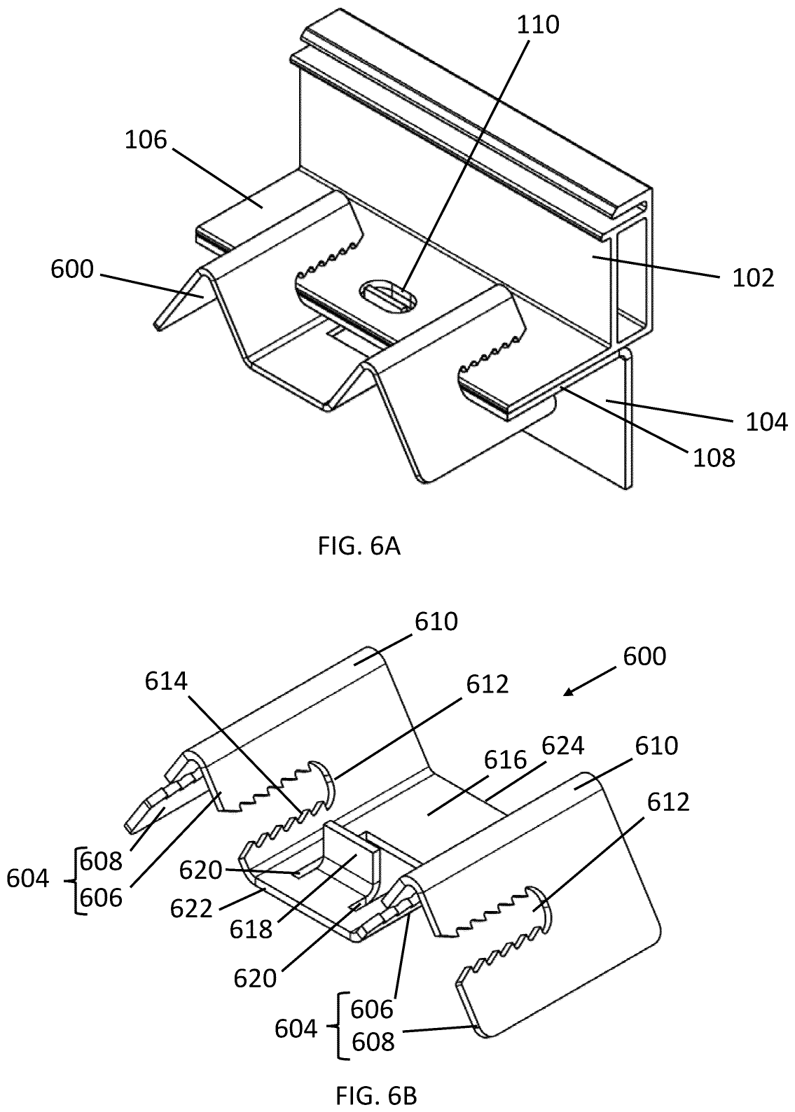

FIGS. 6A and 6B shows another embodiment of a spring clamp 600 attached to panel horizontal flange 106 and bracket horizontal flange 108 that may also aid in preventing lateral movement and retraction. The spring clamp 600 incudes with a bridge tab that is disposed on and extending away from a bridge 616 as elaborated on below. The bridge 616 may have a construction similar to the embodiments described previously above.

In some embodiments, it may be desirable for spring clamp to include a locking feature configured to be engaged with and retain mounting holes 110 or other holes formed in a panel horizontal flange 106, bracket horizontal flange 108, and/or other appropriate structures when the spring clamp 600 is attached thereto. Such a configuration may prevent longitudinal retraction and lateral movement of the spring clamp 600 relative to the flanges 106 and 108 when the spring clamp 600 is attached. Also, a retention tab disposed in mounting holes 110 in both the panel horizontal flange 106 and base horizontal flange 108 may assist in maintaining alignment of the PV panel with the base because the retention tab ensures the mounting holes 110 are aligned with each other. Additionally, a retention tab disposed in mounting holes 110 may ensure proper alignment of the spring clamp 600 relative to the mounting holes 110, preventing stress concentrations resulting from clamping force from one of receiver slots 612 being applied too close to the mounting holes 110.

In view of the above, a retention tab 618 may be disposed on and extend away from the bridge 616 in a direction that is oriented towards a plane that passes through the receiver slots 612 formed in the sets of legs 604. In some embodiments, an angle between a distal face of the retention tab (i.e., the face oriented towards a distal end of the spring clamp in which the openings of the receiver slots 612 are formed) and the bridge 616 is between or equal to 60 degrees and 90 degrees. Additionally, the retention tab 618 may extend above the lower surfaces of the receiver slots 612 closer to the bridge 616 such that a plane passing through the lower surfaces of the receiver slots is disposed between an end portion of the retention tab 618 and a portion of the retention tab 618 attached to the bridge 616. Accordingly, the retention tab may extend vertically from the bridge 616 by a distance that is sufficient such that it may be disposed inside mounting holes 110, or other holes of a structure received in the receiver slots 612, when the spring clamp 600 is attached thereto.

Retention tab 618 is configured to be compliant such that it may bend from its initial configuration to a more angled or bent configuration when a force is applied to the retention tab 618. The retention tab may exhibit sufficient elasticity such that it returns to that initial configuration when the force is removed. Accordingly, as the receiver slots 612 of the spring clamp 600 are advanced over flanges 106 and 108, contact between the retention tab 618 and these structures causes it to bend towards the bent configuration to permit the structures to be inserted into the receiver slots 612. Once the spring clamp 600 advanced by a sufficient distance over the flanges 106 and 108, retention tab 618 will be aligned with mounting holes 110. The retention tab 618 is then released permitting the retention tab 618 to return to the initial undeformed configuration within the mounting holes 110 of the flanges. Due to the retention tab 618 now being disposed within the mounting holes, relative lateral movement of the spring clamp and clamped structures (i.e., the PV panel and bracket) may be prevented by the retention tab 618.

In some embodiments, a retention tab 618 may be made by cutting the retention tab from a section of the elongate bridge 616 and bending the retention tab 618 out of plane such that retention tab 618 extends vertically upwards at any appropriate angle relative to the elongate bridge 616 as noted above. In some embodiments, elongate bridge 616 may include relief slots 620 formed on either side of the retention tab 618 and extending in a distal direction from a vertical portion of the retention tab 618. In such an embodiment, the retention tab may include a first portion that is parallel to an adjacent portion of the bridge 616 and a second portion that is angled relative to the bridge. Such a configuration may improve the ability of the retention tab to bend under an applied load.

In some embodiments, retention tab 618 may extend vertically above a bridge by a height between 3 mm and 9 mm. In some embodiments, a width of retention tab 618 may be between 6 mm and 12 mm. In some embodiments, relief slots 620 may extend distally between 1 mm and 5 mm past the retention tab 618. Of course, other dimensions for the overall spring clamp and the associated retention tab may also be used as the disclosure is not so limited.

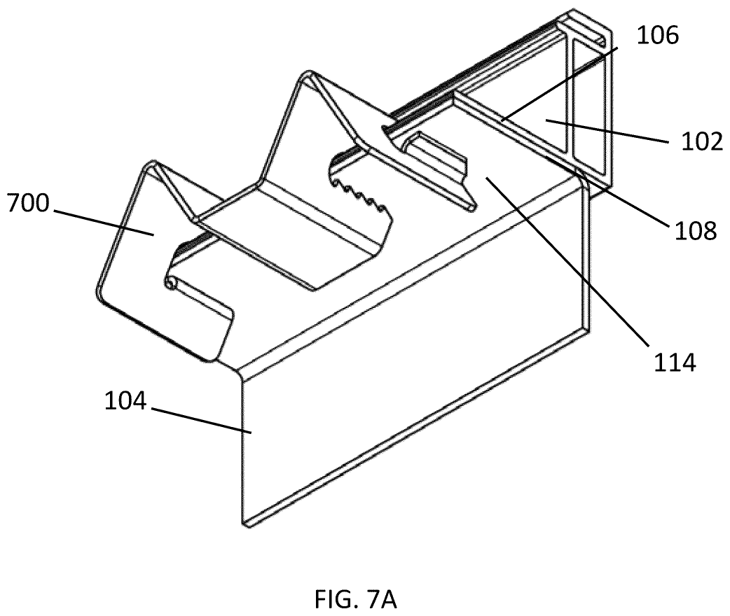

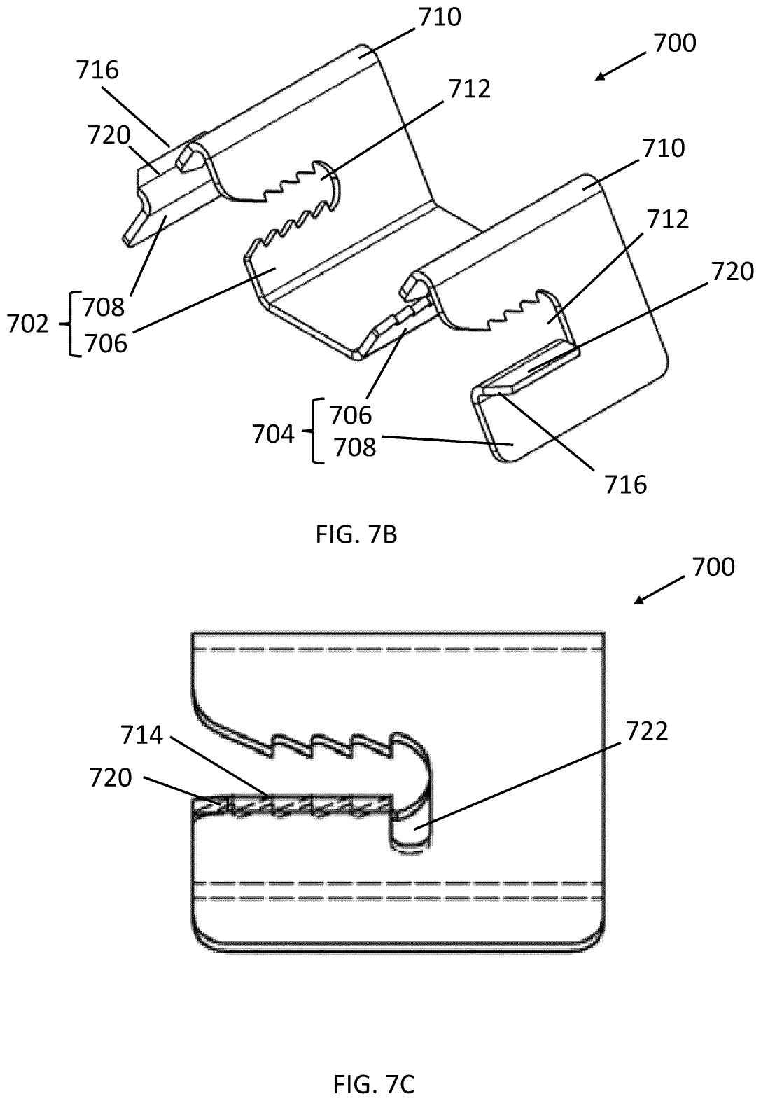

Wind may cause uplift loads on PV panels when wind passes through gaps between PV panels and base structures. In some embodiments, it may be desirable to increase an area of the load bearing surface of a spring clamp 700 on an underside surface 114 of the bracket horizontal flange 108. Increasing this area may better distribute wind uplift loads across the bracket horizontal flange 108 to further reduce a likelihood of local deformation of the bracket horizontal flange 108. FIGS. 7A-C show various views of a spring clamp with load distribution flanges, and of a spring clamp with load distribution flanges attached to a bracket horizontal flange and panel horizontal flange.

In some embodiments, spring clamps 700 may include load distribution flanges 720 along a lower edge 714 of the receiver slots 712 in the exterior legs 708 of the two exterior clamp sections corresponding to sets of legs 702 and 704 disposed on opposing end portions of the spring clamp. The load distribution flanges extend along at least a portion of a length of the receiver slots 712, and in some embodiments a majority of a length of the receiver slots 712.

The load distribution flanges also extend in a direction that is oriented outwards away from the associated exterior legs 708. When legs 706 and 708 are compressed, load distribution flanges 720 rotate with the receiver slots 712 on the outer legs 708 to allow for the increased clearance provided by the receiver slots 712 in the compressed configuration. The receiver slots 712 of the spring clamp 700 is then advanced over the panel horizontal flange 106 and the bracket horizontal flange 108. Once the spring clamp 700 is fully advanced over the flanges 106 and 108, the compressive force on the legs 706 and 708 is removed to allow the legs 706 and 708 to move towards the relaxed configuration such that the clamp is engaged with the structures in an engaged configuration. This forces the load distribution flanges 720 into contact with an adjacent surface 114 of the bracket horizontal flange 108 or other structure distributing the clamping force over a larger area.

In some embodiments, load distribution flanges 720 are made by cutting the load distribution flanges 720 from the outer legs 708 and bending the load distribution flanges 720 outwards away from the outer legs 708, thus forming a lower edge 714 of the receiver slots 712 on the outer legs 708. Load distribution flanges 720 may be bent to any suitable angle relative to the outer legs 708. In some embodiments, the load distribution flanges 720 are between 40° and 80° relative to the outer legs 708. A maximum width which the load distribution flanges 720 may extend outwards away from the outer legs 708 is limited to an overall height of the receiver slots 712 they are cut from. In some embodiments receiver slot 712 may have an overall height between 2 mm and 4 mm. In some embodiments spring clamps 700 may include relief slots 722 at a proximate end portion of the load distribution flanges 720 to allow for the load distribution flanges 720 to be bent to the desired angle. In some embodiments, the length of load distribution flanges 720 may be between 50% and 90% of the depth of the receiver slot 712. In some embodiments receiver slot 712 may have a depth between 10 mm and 30 mm. Of course, other dimensions may be used for these features as well as the disclosure is not so limited.

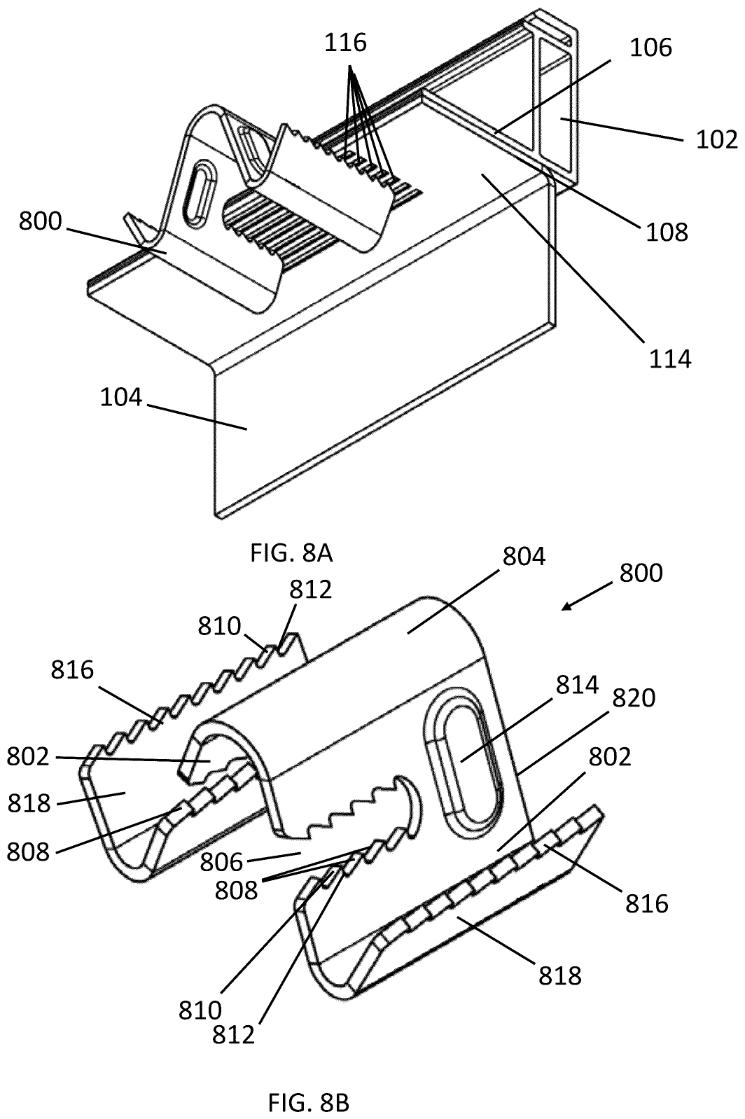

In some embodiments, it may be desirable for spring clamps 800 to be able to incrementally advance over the panel horizontal flange 106 and bracket horizontal flange 108 while being prevented retraction. FIGS. 8A-8B show one embodiment of such a spring clamp 800 attached to panel horizontal flange 106 and bracket horizontal flange 108 that include interlocking features to prevent removal from the spring clamp.

In some embodiments, an underside surface 114 of the bracket horizontal flange 108 or other structure that oriented away from the PV panel and is configured to be engaged with the spring clamp 800 may include a series of parallel grooves 116 that extend along at least a portion of an edge of the flange. Spring clamp 800 includes at least one set of two legs 802 extending from a common apex 804, though embodiments including multiple clamp sections as detailed above may also be used. Similar to the above embodiments, separate receiver slots 806 are formed in each of the legs 802. In the depicted embodiment, the lower receiver slot teeth 808 formed in one or more, and in some embodiments all, of the receiver slots 806 are formed on a lower edge of receiver slots 806 configured to be engaged with the grooves 116. Lower receiver slot teeth 808 may be asymmetrical in some embodiments to facilitate. For example, each tooth may have a first slope along a leading edge 810 oriented towards an opening of the receiver slot 806 and a steeper second slope along a trailing edge 812 oriented away from the opening of the receiver slot located on a distal end portion of the spring clamp 800. As the receiver slots 806 of the spring clamp 800 are advanced over the horizontal flanges 106 and 108, leading edges 810 of lower receiver slot teeth 808 are pushed over and into the parallel grooves 116. Spring clamps 800 are then prevented from being retracted from the horizontal flanges by contact between the parallel grooves 116 and the trailing edges 812 of the lower receiver slot teeth when the clamp is in the engaged configuration.

In some embodiments, it may be desirable to increase stiffness of the spring clamps 800 without increasing the thickness of the material used to form the spring clamps 800 or increasing a length of the spring clamps between receiver slots 806 and proximal end 820 of the spring clamp 800. Spring clamps 800 may therefore include one or more stiffening ribs 814 formed on one or more corresponding legs 802. Stiffening ribs 814 may be included on any combination of legs from any of the embodiments of spring clamps described herein. Stiffening ribs 814 may be formed using any conventional process, such as by embossing. In some embodiments, stiffening ribs 814 may be located adjacent to and proximal to the receiver slots 806 (i.e., opposite from the openings of the receiver slots 806) such that the stiffening rib extends between opposing portions of the leg extend above and below the receiving adjacent receiver slot 806. This may help to stiffen this portion of the leg which may be beneficial due to the receiver slots causing this portion of the legs to be more flexible as compared to other portions of the legs.

In some embodiments, in addition or as an alternative to including additional clamp sections with additional receiver slots with corresponding teeth, a spring clamp 800 may include additional lower teeth 816 disposed on flanges 818. Flanges 818 may be connected to the lower portions of the exterior legs 802 located opposite the apex joint 804. The flanges 818 may extend in a direction that is oriented up and outwards relative to the end portions of the exterior legs such that the end portions of the flanges 818 and the teeth 816 disposed thereon may be configured to be engaged with and interlock with parallel grooves 116 formed on a corresponding structure similar to that described above. Such additional lower teeth 816 may increase a load distribution area of the clamping force on an underside surface of the bracket horizontal flange, thus reducing a risk of local deformation of the bracket horizontal flange. Additional lower teeth 816 may also increase a resistance of the spring clamp 800 from being retracted from flanges 106 and 108 by increasing the amount of contact between trailing edges 812 and parallel grooves 116.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A clamp for connecting a bracket to a frame, the clamp comprising:
a first clamp section comprising:
a first pair of legs configured to move between a compressed configuration with the first pair of legs compressed towards one another and an expanded configuration; and
a first plurality of receiver slots, each of the first plurality of receiver slots formed in a respective one of the first pair of legs, wherein the first plurality of receiver slots is configured to receive a portion of the bracket and a portion of the frame therein;
a second clamp section connected to the first clamp section, the second clamp section comprising:
a second pair of legs configured to move between a compressed configuration with the second pair of legs compressed towards one another and an expanded configuration; and
a second plurality of receiver slots, each of the second plurality of receiver slots formed in a respective one of the second pair of legs, wherein the second plurality of receiver slots are configured to receive a portion of the bracket and a portion of the frame therein; and
a flexible connection extending between and connecting the first clamp section and the second clamp section, wherein the first plurality of receiver slots is aligned with the second plurality of receiver slots such that a plane extends through both the first plurality of receiver slots and the second plurality of receiver slots in both the compressed configurations and the expanded configurations.

2. The clamp of claim 1, wherein the flexible connection comprises a bridge extending between the first clamp section and the second clamp section.

3. The clamp of claim 2, further comprising a tab disposed on and extending out from the bridge, wherein the tab is configured to engage and be retained in an opening formed in at least one of the bracket or the frame.

4. The clamp of claim 3, wherein the tab is integrally formed with the bridge and is deformed out of plane with the bridge.

5. The clamp of claim 3, further comprising relief slots disposed adjacent to a connection between the tab and the bridge, wherein the relief slots are configured increase a flexibility of the tab to an applied force.

6. The clamp of claim 1, wherein the first pair of legs meet at a first apex, and the second pair of legs meet at a second apex.

7. The clamp of claim 6, wherein load distribution flanges form edges of at least one of the first plurality of receiver slots and at least one of the second plurality of receiver slots, wherein the load distribution flanges are configured to press against a surface of the bracket, and wherein the edges of at least one of the first plurality of receiver slots and at least one of the second plurality of receiver slots are edges furthest from the first apex and second apex.

8. The clamp of claim 1, further comprising a plurality of teeth formed in at least one of upper edges or lower edges of the first plurality of receiver slots and in at least one of upper edges or lower edges of second plurality of receiver slots.

9. The clamp of claim 1, wherein the clamp is formed from a single piece of sheet metal.

10. The clamp of claim 1, further comprising one or more stiffening ribs formed on one or more legs of the first and second legs, wherein each stiffening rib is located adjacent to an associated receiver slot of an associated leg of the one or more legs.

11. The clamp of claim 1, further comprising one or more additional clamp sections disposed between the first clamp section and the second clamp section.

12. The clamp of claim 1, further comprising a plurality of relief slots, wherein each relief slot of the plurality of relief slots is associated with one receiver slot of the first and second plurality of receiver slots.

13. A clamping system for clamping a solar panel to a base, the clamping system comprising:
a bracket of the base;
a frame of the solar panel; and
a clamp configured to approximate the bracket to the frame, the clamp comprising:
a first clamp section comprising:
a first pair of legs configured to move between a compressed configuration with the first pair of legs compressed towards one another and an expanded configuration; and
a first plurality of receiver slots, each of the first plurality of receiver slots formed in a respective one of the first pair of legs, wherein the first plurality of receiver slots is configured to receive a portion of the bracket and a portion of the frame therein;
a second clamp section connected to the first clamp section, the second clamp section comprising:
a second pair of legs configured to move between a compressed configuration with the second pair of legs compressed towards one another and an expanded configuration; and
a second plurality of receiver slots, each of the second plurality of receiver slots formed in a respective one of the second pair of legs, wherein the second plurality of receiver slots are configured to receive a portion of the bracket and a portion of the frame therein; and
a flexible connection extending between and connecting the first clamp section and the second clamp section, wherein the first plurality of receiver slots is aligned with the second plurality of receiver slots such that a plane extends through both the first plurality of receiver slots and the second plurality of receiver slots in both the compressed configurations and the expanded configurations.

14. The clamping system of claim 13, wherein the flexible connection comprises a bridge extending between the first clamp section and the second clamp section.

15. The clamping system of claim 14, further comprising a tab disposed on and extending out from the bridge, wherein the tab is configured to engage and be retained in an opening formed in at least one of the bracket or the frame.

16. The clamping system of claim 15, wherein the tab is integrally formed with the bridge and is deformed out of plane with the bridge.

17. The clamping system of claim 15, further comprising relief slots disposed adjacent to a connection between the tab and the bridge, wherein the relief slots are configured increase a flexibility of the tab to an applied force.

18. The clamping system of claim 13, wherein the first pair of legs meet at a first apex, and the second pair of legs meet at a second apex.

19. The clamping system of claim 18, wherein load distribution flanges form edges of at least one of the first plurality of receiver slots and at least one of the second plurality of receiver slots, wherein the load distribution flanges are configured to press against a surface of the bracket, and wherein the edges of at least one of the first plurality of receiver slots and at least one of the second plurality of receiver slots are edges furthest from the first apex and second apex.

20. The clamping system of claim 13, further comprising a plurality of teeth formed in at least one of upper edges or lower edges of the first plurality of receiver slots and in at least one of upper edges or lower edges of second plurality of receiver slots.

21. The clamping system of claim 13, wherein the clamp is formed from a single piece of sheet metal.

22. The clamping system of claim 13, further comprising one or more stiffening ribs formed on one or more legs of the first and second legs, wherein each stiffening rib is located adjacent to an associated receiver slot of an associated leg of the one or more legs.

23. The clamping system of claim 13, further comprising one or more additional clamp sections disposed between the first clamp section and the second clamp section.

24. The clamping system of claim 13, further comprising a plurality of relief slots, wherein each relief slot of the plurality of relief slots is associated with one receiver slot of the first and second plurality of receiver slots.

25. A method of connecting a bracket to a frame, the method comprising:
applying an external force to a clamp to transition a first pair of legs of the clamp and a second pair of legs of the clamp connected to the first pair of legs from a first expanded configuration to a second compressed configuration;
receiving a portion of the bracket and a portion of the frame within a plurality of receiver slots, each of the plurality of receiver slots formed in a respective one of each of the first pair of legs and second pair of legs; and
removing the external force from the first pair of legs and from the second pair of legs to allow the first and second pairs of legs to at least partially return to the first expanded configuration to clamp the bracket and frame in each of the plurality of receiver slots.

26. The method of claim 25, further comprising scratching at least one of the bracket or the frame with teeth formed in the plurality of receiver slots.

27. The method of claim 25, further comprising retaining a tab disposed on and extending out from a bridge of the clamp in at least one opening formed in at least one of the frame and the bracket.

28. The method of claim 25, further comprising retaining a plurality of locking tabs extending from the plurality of receiver slots in an exterior leg of the first pair of legs and an exterior leg of the second pair of legs in openings formed in at least one of the frame and the bracket.

29. The method of claim 25, further comprising pressing load distribution flanges formed on a lower edge of at least one of the plurality of receiver slots against a bottom surface of the bracket.

30. The method of claim 25, wherein applying an external force to a clamp comprises applying an external force to an exterior leg of the first pair of legs of a clamp and to an exterior leg of the second pair of legs of the clamp.

31. A clamping system comprising:
a bracket including a plurality of grooves formed on a lower surface of the bracket, wherein the plurality of grooves extends substantially parallel to an edge of the bracket; and
a clamp configured to approximate the bracket to a frame, the clamp comprising:
a pair of legs configured to move between a compressed configuration with the pair of legs compressed towards one another and an expanded configuration;
a plurality of receiver slots, each of the plurality of receiver slots formed in a respective one of the pair of legs, wherein the plurality of receiver slots is configured to receive a portion of the bracket and a portion of the frame therein; and
a plurality of teeth extending from one or more edges of each of the plurality of receiver slots and configured to interlock with the plurality of grooves to prevent movement of the clamp relative to the bracket in a direction substantially parallel to a direction in which the plurality of receiver slots extends.

32. The clamping system of claim 31, wherein the frame is a frame of a solar panel.

33. The clamping system of claim 31, wherein the pair of legs is a first pair of legs, further comprising a second pair of legs connected to the first pair of legs, and a flexible connection extending between and connecting the first pair of legs to the second pair of legs.

34. The clamping system of claim 33, wherein the second pair of legs is symmetrical with the first pair of legs.

35. The clamping system of claim 31, further comprising one or more flanges extending from one or more legs of the pair of legs, wherein the one or more flanges comprise a plurality of teeth extending along an edge of the one or more flanges and configured to interlock with the plurality of grooves.

36. The clamping system of claim 31, further comprising one or more stiffening ribs formed on one or more legs of the pair of legs, wherein each stiffening rib is located adjacent to an associated receiver slot of an associated leg.

37. A method connecting a bracket to a frame, the method comprising:
applying an external force to a clamp to transition a first exterior leg and a second exterior leg of the clamp from an expanded configuration to a compressed configuration;
receiving a portion of the bracket and a portion of the frame within a plurality of receiver slots, each of the plurality of receiver slots formed in a respective one of the first and second exterior legs;
removing the external force from the first exterior leg and the second exterior leg to allow the first and second exterior legs to at least partially return to the expanded configuration; and
preventing movement of the clamp relative to the bracket in a direction substantially parallel to a direction in which the plurality of receiver slots extend by interlocking a plurality of teeth extending along a lower edge of each of the plurality of receiver slots with a plurality of grooves extending at least partially along an edge of the bracket on a lower surface of the bracket.

38. The method of claim 37, further comprising scratching at least one of the bracket or the frame with teeth formed in the plurality of receiver slots.

39. The method of claim 37, further comprising retaining a plurality of locking tabs extending from receiver slots of the plurality of receiver slots formed in the first and second exterior legs in openings formed in at least one of the frame and the bracket.

40. The method of claim 37, further comprising interlocking a plurality of teeth extending along one or more flanges extending from one or more of the first exterior leg and the second exterior leg with the plurality of grooves.

41. The method of claim 37, wherein applying an external force to the clamp comprises applying an external force to the first exterior leg and a second exterior leg of the clamp.
